(19) United States
(12) Patent Application Publication
(10) Pub. No.: US 2002/0151998 A1
(43) Pub. Date: Oct. 17, 2002

(54) Method and system for creating and presenting an individual audio information program

(76) Inventors: Yrjo Kemppi, Ratingen (DE); Uwe Pertz, Bergheim (DE); Razvan Olosu, Dusseldorf (DE); Iikka Ratamo, Vaskio (FI); Pirio Larima, Duisburg (DE); Ari Salomaki, Tampere (FI)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/108,368

(22) Filed: Mar. 29, 2002

(30) Foreign Application Priority Data
Mar. 30, 2001 (EP) 01 108 162.7

(51) Int. Cl. G06F 17/00; G10L 11/00; G10L 21/00

(52) U.S. Cl. 700/94; 704/270

(57) ABSTRACT

The present invention relates to a method and a system for creating and presenting an individual audio information program. At a program creating side desired information from information provided at an information providing site (13) is chosen by means of a peripheral device (10) for selecting and receiving information from the information providing site (13). Upon receiving chosen information is stored in a memory means (17). At a program presenting side information from the information stored in the memory means (17) is selected and presented as audio information. The provides a method and a system that is easy to use at low costs.

### DESCRIPTION

The present invention relates to a method and a system for creating and presenting an individual audio information program.

If someone wants to get any kind of information or entertainment he/she has usually several possibilities of getting the desired information and/or listening to desired news or music. Usually a user can listen to a radio broadcast program, to a CD or a tape from his/her own collection. Further, it is possible to get music information, in particular according to the MP3 standard via the Internet which also provides news and a lot of other information.

Therefore, a user usually gets all information and entertainment according to her/his interests.

However, today drivers in vehicles are dependent on CD players, cassette players and radio stations to listen to music or news. Therefore drivers has only the choice between the CDs and/or cassettes actually present in the vehicle and radio broadcast programs or services which are not personalized.

The object underlying the present invention is to provide a method and a system of the initially named kind that is easy to use at low costs.

This object is achieved by the method according to claim 1 and by the system according to claim 10.

According to the present invention a user chooses desired information from information provided at an information providing site by means of a peripheral device, e.g. by means of a PC (personal computer) having an Internet portal access, receives the chosen information and stores it in a memory means connected to the peripheral device of the Internet. After storing all desired information in the memory means, i. e. after creating the desired individual audio information program, the memory means is moved to a user terminal preferably in a vehicle so that a user can start presenting the stored information as audio information. According to a prefered embodiment of the present invention the user can select information from the stored information which will be presented thereafter as audio program i.e. as a radio drama or a spoken text like news, sightseeing information, traffic information, route guidance information, stock market information, or the like.

In particular, the invention makes it possible to download audio content files (text to speech) from the Internet to a standard external memory via a peripheral device and play them in the user terminal preferably installed in a vehicle. This provides personalization of the services which every driver can choose beforehand to have a more pleasant and productive journey. When downloading information from the Internet a user or driver would be able to create his/her own radio station program at home or at the office and to listen precisely to what he/her wants, not only to music but to any text file transformed into speech when he/she is driving.

To facilitate the inventive method and to reduce the technical equipment necessary for presenting the stored information as audio information it is preferred, that chosen text information is converted into speech information at the information providing site.

According to a refinement of the present invention it is preferred that information is provided at the information site via a plurality of information channels.

To assist a user in creating her/his individual audio information program it is of advantage if at least one information channel provides access to a personal information site allocated to an individual user by means of an identification code, wherein the information provided at the personal information site is assembled in accordance with the user's former information choosing behavior and/or a user's choosing order.

In particular, assembling just that information a user wants to obtain can be made by an Internet agent, who searchs for specific information or monitors specific information programms selected, indicated or specified by a user to get the information wanted.

By means of the personal information site it is possible for a provider to assemble all information according to information types, like news headlines, special entertainment, favorite programs, weather forecast, or the like, a user usually choose for download prior to the user's request so that the time a user has to spend for choosing and creating his/her individual audio information program can be greatly reduced.

Another refinement of the present invention is characterized in that at least one channel provides access to a private information site allocated to an individual user only by means of an identification code and a security code, wherein information determined for an individual user can be sent to his/her private information site via a radio channel or via Internet.

Further, it is of advantage if access to the information providing site can be established via a radio channel or via Internet for receiving information from the user's own private information site or for transmitting information to any selected private information site.

According to the latter developments of the present invention it is not only possible that a user gets private text information from her/his private information site, for example e-mails sent to and received by her/his private information site, but also to sent speech information as such or as text information to other private information sites so that this information can be dealed with similar to e-mail information.

According to another embodiment of the invention, specific information specified by a user is monitored by a provider or Internet agent and information is tramitted to the user terminal via a wireless communications or radio channel dynamically or automatically when a desired information needs to be up-dated and/or when a user specified condition occurs.

An advantageous development of the present invention is characterized in that the memory means storing chosen information is removed from an information receiving device and connected to a voice interface for presenting the selected information. Preferably, voice parameters related to speakers are provided in the voice interface so that a user can choose who will be the speaker for him/her according to the availalble voice parameters in the voice interface. Thus, the user can decide whether the voice of Marilyn Monroe, Frank Sinatra, Tiger Woods or any other famous person whose voice characteristics is available in the interface, presents the desired audio or speech information.

Accordingly, an advantageous refinement of the inventive system is characterized in that the user terminal includes a voice interface for presenting the selected audio information stored in the memory means.

For controlling the presentation of the desired audio information, i.e. for selecting special pieces of audio information, for example a desired piece of music or a special text information, it is provided, that the user terminal includes a user interface for controlling the presentation of the selected information stored in the memory means.

According to a preferred refinement of the present invention the user terminal is connectable to a telecommunications unit, in particular to a mobile phone, wherein the user terminal is connectable to the information providing site by means of the telecommunications unit.

Therefore, it is not only possible for a user to create and present his/her individual audio information program but also to get urgent information from her/his private information site.

If the user terminal is mounted in a vehicle it is preferred that the user interface of the user terminal includes speech input means for inputting voice information and/or for controlling the user terminal. Consequently, it is possible to control the user terminal by speech commands and to input speech information for any kind of purposes, e.g. for being transmitted as speech or text information to a specific site on an information providing site.

According to a further development of the present invention it is provided that the memory device is detachably mountable to both the user terminal and the peripheral device.

According to a preferred advantageous development of the present invention it is provided that the peripheral device is connectable to the information providing site via an access device in particular for both receiving information from and transmitting information to the information providing site, wherein the peripheral device is a PC (personal computer) connected to the access device via Internet access, wherein the access device is a portal used as entrance of the information providing site.

To protect a personal and/or private information site against unallowed access and against misuse of the information contained in such a personal and/or private information site, a preferred refinement of the present invention is characterized in that a user specific information site is accessible by means of the peripheral device via the portal only by means of a security device, in particular by means of an identification code and/or a security code used as a key or password.

An exemplary embodiment of the present invention is described in detail below with reference to drawings. In the drawings:

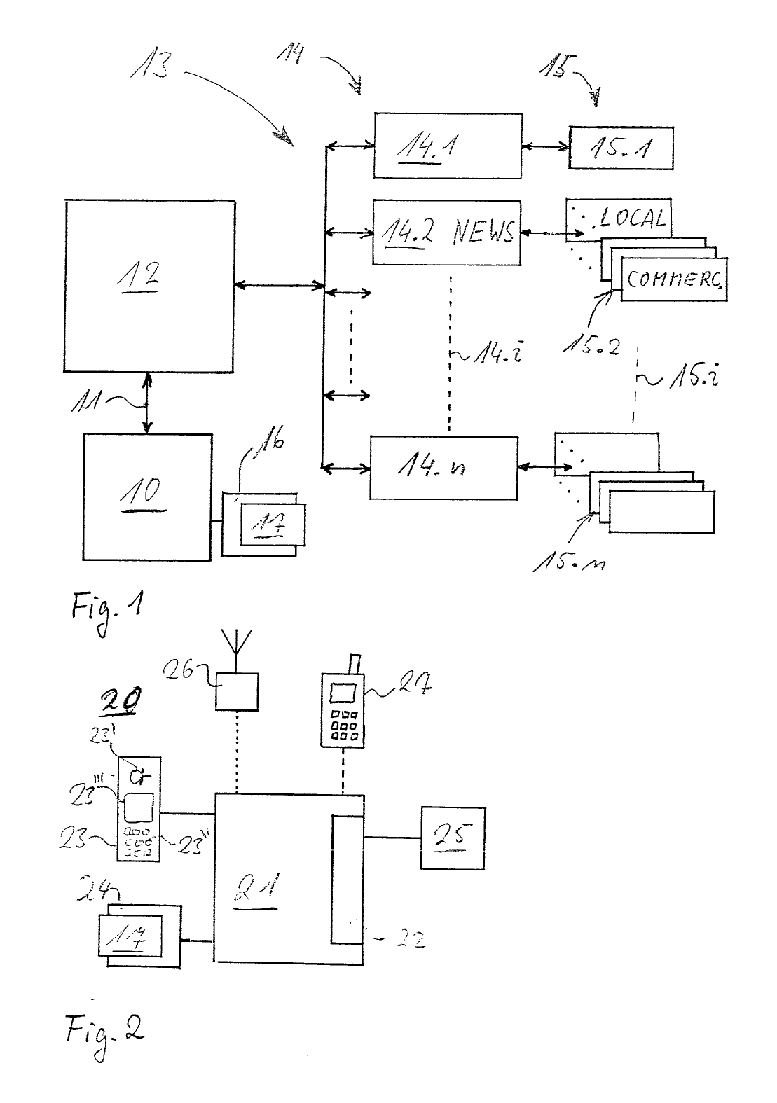

FIG. 1 shows a simplified schematic block diagram of a program creating side of a system according to the present invention, and

FIG. 2 shows a simplified schematic block diagram of a program presenting side of a system according to the present invention.

Identical parts are constantly provided with the same reference symbols throughout the drawings.

According to FIG. 1 the program creating side of the inventive system for creating and presenting an individual audio information program comprises as a peripheral device a home or office PC (personal computer) 10 having an Internet access 11 to a portal 12 forming the entrance to an information providing site 13. The portal 12 is comparable with a super webside of a provider and is used for handling information retrieval, text to speech and speech to text transcoding, customer or user data and customer or user orders.

The portal 12 provides access to a plurality of information channels 14 each of which in turn provides access to one or more information sites 15. This information sites 15 can be for example a private information site 15.1 only accessible via a personal information channel 14.1 by use of an identification code and by a security code. Other information sites 15.2 may be websides of subprovider delivering specific information such as entertainment information or special business information, news, pieces of music according to the MP3-standard, and the like. Other examples for information sites 15 accessible via a specific channel 14.i are the webside of a traffic provider providing actual traffic information like route guidance information, traffic situation information, traffic specific weather information, and the like.

To store information retrieved from the information providing site 13 via the portal 12 and the Internet access 11 the PC 10 as receiving device is connected to a memory device 16 suitable for detachably receiving a memory means 17 for writing information into the memory means 17 and if suitable or desired for reading information from the memory means 17. For example a memory card writer/reader can be used as memory device 16 in case that memory cards should be used as memory means 17. However, other devices such as CD writer can be used as memory device 16 also.

After retrieving all desired information and creating an individual audio information program which will be explained in more detail herein after, the memory means 17 is detached from the memory device 16 and transferred to the program presenting side.

According to FIG. 2 the program presenting site includes a user terminal 20 having a control unit 21 provided with an MP3 player (not shown) and a voice interface 22 and connected with a user interface 23 and a memory device 24 for detachably receiving the memory means 17. Instead of an MP3 player which is mentioned as an example only, any other suitable audio player can be used. For presenting audio information the voice interface 22 is connected to a sound system 25.

If the user terminal 20 is installed in a vehicle it is possible that the sound system mounted in the vehicle can be used as sound system 25 for presenting speech and other audio information. However, the user terminal can be also connected to a separate sound system 25.

In particular, if the user terminal 20 of the information presenting side is installed in a vehicle, the control unit 21 can be optionally connected to a GPS-(global positioning system) module 26 for receiving position data of the actual position of the device, i.e. of the vehicle, for use with a route guidance method. Further, a mobile tele communications unit, e.g. a mobile phone 27 can be detachably connected with the control unit 21 of the user terminal 20.

Next, an exemplary process for creating an individual audio information program will be described in more detail.

First, a user will establish access to a provider's portal 12 by means of her/his PC 10 via Internet access 11. Thereafter the user can choose anyone of a plurality of information channels 14 for retrieving desired information provided by one or more (sub)-service providers. For example, the user can choose (14.2) of the information channels for getting news and thereafter he can decide which kind of news he would like to listen to.

Therefore, she/he can select one of a plurality of news information sites 15.2 presenting different kinds of news, for example local news, news of the world, sport news, society news, scientific news, commercial news and the like.

Via another information channel 14.i she/he can get an entertainment information or programs like games or sightseeing information related to specific routes. In particular, for getting sightseeing information the user has to indicate a route along which he will travel in the next time. Preferably, position data are associated with the sightseeing news so that it is possible to select specific pieces of the sightseeing news in dependence on the user's position during presenting this sightseeing news.

Further, another information channel 14.i may provide access to an information site 15.i containing an audio book library for retrieving a novel, a short story or an essay of a specific author. Furthermore, another information channel 14.i may provide access to pieces of music provided according to the MP3 standard.

In addition, a private information site 15.1, for example a private e-mail box may be contacted for retrieving the users e-mail via the personal information channel so that he/she can listen to his/her e-mails when driving to work or any other destination. The e-mail text are preferably converted into speech information according to a text-speech conversion so that the e-mail text can be presented by a voice output realized by the voice interface 22. For such a voice output the user will be able to choose who will be the speaker for him/her if the voice parameters are available in the voice interface 22. In this case, the user can decide whether the voice of Marilyn Monroe, Frank Sinatra, Tiger Woods or any other famous person whose voice characteristics can be copied presents the desired audio or speech information. Further, it is possible to get company specific information from the webside of a company to be visited by the user so he/she can listen to this information when driving to this company. Such company information may be also available from a private information site of the user or from a private information site of her/his company access to which is only possible for authorized people.

Furthermore, one information channel may be used for getting route guidance information from a traffic information and route guidance provider.

It is clear from the above description that the user of the inventive system can get any kind of information from any Internet provider according to the present and future possibilities of the Internet.

Information, that is only provided as text will be converted into speech after selecting and retrieving from the specific information site by the entrance provider running the portal 12, so that the user always get information suitable for presenting as audio information by a sound system 25 via a voice interface 22 or in case of music via an MP3 player which should be integrated in or connected to the control unit 21 of the user terminal 20.

To assist a user in creating his/her individual audio information program it is possible, to determine the user's information choosing behavior so that only those information channels are presented to the user which he/she usually choose. Further, it seems to be possible to provide a personal information site for a user accessible via the personal information channel 14.1 so that actual information can be assembled onto this personal information site by a provider in accordance with the user's former information choosing behavior and/or a user's choosing order. In this case it seems to be possible that a user requests the information she/he usually choose and in addition another information, e.g. specific sightseeing information for a specific route he will travel along the next day to visit a customer or a colleague, route guidance information and specific information about his/her customer or colleague from his/her respective webside. Thereafter, the service provider will assemble the requested information on the user's personal information site so that this information can be get from the personal information site for being stored within the memory means 17 either automatically or upon a specific down-load request.

After creating an individual audio information program as described the memory means 17 will be detached from the memory device 16 and transferred to the memory device 24 of the user terminal 20 preferably mounted in a vehicle.

After inserting the memory means 17 that stores the individual audio information program, into the memory device 24 of the user terminal 20 the user can start the individual audio information program via the user interface 23 so that the program will be sequentially presented in the same order as it has been stored.

However, it is also possible to select a special sequence for presenting the different kinds of information. In addition, a user can also interrupt the presentation of the program to replay a specific piece of music or a specific text information.

In addition, if sightseeing information associated with position data is stored in the memory means 17 and a GPS module 26 is connected to the control unit 21 the user has preferably the possibility to select a special mode for presenting the sightseeing information in accordance with the user's position. For example, it is possible to interrupt the program when the user reaches a point of interest and the sightseeing information related to this point of interest will be presented. Thereafter the interrupted program will be continued.

To avoid the interruption of a specific presentation of information, for example the presentation of route guidance information priorities can be associated with any type of stored information. For example, a high priority can be associated with route guidance information and pieces of music can be associated with a low priority whereas sightseeing information is associated with medium priority so that the presentation of route guidance information will not be interrupted when a specific point of interest is reached for informing a user about this point of interest. However, the presentation of a piece of music that has a low priority will be interrupted for presenting the information related to the actual point of interest.

Please note that the term sightseeing information as used in this application will not only mean the history of buildings and places but also any kind of information about a region for example information about the nearest golf course or the next restaurants or the like.

Furthermore, if the user terminal 20 is connected with a mobile phone 27 it is possible for a user to receive his/her e-mails via a wireless communications or radio channel.

In addition, it is possible to receive information via the wireless communications or radio channel not only upon request, but also dynamically or automatically when a desired information needs to be up-dated. E. g. traffic information will be transmitted to the user terminal 20, in any case the traffic situation changes. Thus, the driver of a vehicle receives always the actual traffic information.

According to another embodiment, it is possible that a provider or Internet agent monitors e. g. stock market information, in particular the stock market price of a specific share and informs the user when the price of this share has reached a user specified limit automatically.

The present invention provides a method and a system for presenting any kind of audio and text information via an audio interface so that it is possible for a user to listen to the information and to get text information even she/he is driving in a vehicle. Using a personalized information channel or information site it is possible to retrieve easily information concerning the special interests of the user, e.g. to get favorite sport results, financial news, different types of music, and the like.

The program creating side allows automatic service download through the Internet. In particular, the user can preset a time when he/she want the desired and selected information to be downloaded to the memory means.

An essential advantage of the inventive method and system is that a user can create an individual audio information program at low costs since the Internet connection is cheaper than a tele communications connection.

1. A method for creating and presenting an individual audio information program, comprising the steps of:
choosing desired information from information provided at an information providing site (13),
receiving chosen information and storing it in a memory means (17), and
presenting the information stored in the memory means (17) as audio information.

2. The method as claimed in claim 1, characterized by selecting information from the information stored in the memory means (17) to present the selected information as audio information.

3. The method as claimed in claim 1 or 2, characterized in that chosen text information is converted into speech information at the information providing site (13).

4. The method as claimed in claim 1, 2 or 3, characterized in that information is provided at the information site (13) via a plurality of information channels (14).

5. The method as claimed in claim 4, characterized in that at least one information channel (14) provides access to a personal information site allocated to an individual user by means of an identification code.

6. The method as claimed in claim 5, characterized in that the information provided at the personal information site is assembled in accordance with the user former information choosing behavior and/or a users choosing order.

7. The method as claimed in claim 4, 5 or 6, characterized in that at least one channel (14.1) provides access to a private information site (15.1) allocated to an individual user only by means of an identification code and a security code.

8. The method as claimed in claim 7, characterized in that information determined for an individual user can be sent to his/her private information site via a radio channel or via Internet.

9. The method as claimed in claim 7 or 8, characterized in that access to the information providing site (13) can be established via a radio channel or via Internet for receiving information from the user's own private information site or for transmitting information to any selected private information site.

10. The method as claimed in any one of the preceding claims characterized in that the memory means storing chosen information is removed from an information receiving device and connected to a voice interface (22) for presenting the selected information.

11. The method as claimed in any one of the preceding claims characterized in that specific information specified by a user is monitored by a provider or Internet agent and information is tramitted to the user terminal via a wireless communications or radio channel dynamically or automatically when a desired information needs to be up-dated and/or when a user specified condition occurs.

12. A system for creating and presenting an individual audio information program, comprising:
a peripheral device (10) for selecting and receiving information from an information providing site (13) and for storing the received audio information in a memory means (17), and
a user terminal (20) for selectively presenting the information stored in the memory means (17) as audio information.

13. The system as claimed in claim 12, characterized in that the user terminal (20) includes a voice interface (22) for presenting the selected audio information stored in the memory means (17).

14. The system as claimed in claim 13, characterized in that voice parameters related to speakers are provided in the voice interface (22) so that a user can choose who will be the speaker for him/her according to the availalble voice parameters in the voice interface (22).

15. The system as claimed in claim 12, 13 or 14, characterized in that the user terminal (20) includes a user interface (23) for controlling the presentation of the selected information stored in the memory means (17).

16. The system as claimed in claims 12 to 15, characterized in that the user terminal (20) is connectable to a tele communications unit, in particular to a mobile phone (27).

17. The method as claimed in claim 16, characterized in that the user terminal (20) is connectable to the information providing site (13) by means of the tele communications unit (27).

18. The system as claimed in any one of the claims 12 to 17, characterized in that the user interface (23) of the user terminal (20) includes speech input means (23′) for inputting voice information and/or for controlling the user terminal (20).

19. The system according to any one of the claims 12 to 18, characterized in that the memory device (17) is detachably mountable to both the user terminal (20) and the peripheral device (10).

20. The system as claimed in any one of the claims 12 to 19, characterized in that the peripheral device (10) is connectable to the information providing site (13) via an access device (12) in particular for both receiving information from and transmitting information to the information providing site (13).

21. The system as claimed in any one of the claims 12 to 20, characterized in that the peripheral device is a PC (personal computer) (10) connected to the access device via Internet access (11), wherein the access device is a portal (12) used as entrance to the information providing site (13).

22. The system according to any one of the claims 12 to 21, characterized in that a user specific information site (15.1) is accessible by means of the peripheral device (10) via the portal (12) only by means of a security device, in particular by means of an identification code and/or a security code used as a key or password.
